(19) United States
(12) Patent Application Publication
(10) Pub. No.: US 2020/0371496 A1
(43) Pub. Date: Nov. 26, 2020

(54) PUMP MONITORING AND CONTROL NETWORK

(71) Applicant: Baker Hughes Oilfield Operations LLC, Houston, TX (US)

(72) Inventor: Rawshan Monier Abdeldaim, Salmlya City (KW)

(21) Appl. No.: 16/871,606

(22) Filed: May 11, 2020

Related U.S. Application Data
(60) Provisional application No. 62/851,750, filed on May 23, 2019.

(51) Int. Cl. G05B 19/416; H04B 1/3827; H04L 12/24; H04L 29/12

(52) U.S. Cl. CPC G05B 19/416; H04B 1/3827; H04W 84/18; H04L 61/2007; G05B 2219/41303; H04L 41/0806

(57) ABSTRACT

Systems, methods, and a computer readable medium are provided for configuring a network for a pump monitoring and control system in a fluid production environment. A network can be configured between two or more computing devices configured to receive pump sensor data. A first computing device can receive the pump sensor data to be transmitted via a first wireless transceiver to a second computing device configured with the first wireless transceiver, a second wireless transceiver, and a remote field controller. The second computing device can further transmit the sensor data to a pump monitoring and control server, including a central field controller, via a second network using the second wireless transceiver. The server can process and provide the sensor data.

### RELATED APPLICATION

This application claims priority under 35 U.S.C. § 119(e) to U.S. Provisional Application No. 62/851,750 filed May 23, 2019, the entire contents of which are hereby expressly incorporated by reference herein.

### BACKGROUND

A fluid production environment can include multiple well sites, each configured with one or more pumping systems that are used to collect fluids, for example oil, for further processing and distribution. The pumping systems can include a variety of machinery used in the production process. The machinery can be configured to include sensors capable of transmitting sensor data that can be used to monitor and control the machinery.

Supervisory control and data acquisition (SCADA) systems can include monitoring and control systems, which employ computers, communication devices, and networked data communications to monitor and control machinery or systems of machinery based on received sensor data. As computing devices, telecommunications equipment, and networking technologies change, legacy portions of the monitoring and control system can require retro-fitting or upgrades necessary to ensure continued operation of the originally designed system at desired performance levels and costs.

### SUMMARY

In one aspect, methods for implementing a parallel network for pump monitoring and control in a fluid production environment are also provided herein. In one embodiment, the method can include configuring a first network between a first computing device and a second computing device. The method can further include receiving pump sensor data by a first computing device including a data processor and a first wireless transceiver. The pump sensor data can be generated by one or more sensors affixed to a pump within a fluid production environment. The one or more sensors can be coupled to the first computing device. The method can also include transmitting, by the first wireless transceiver of the first computing device, the pump sensor data to a second computing device via the first network. The second computing device can include a data processor a remote field controller, a second wireless transceiver, and a third wireless transceiver. The method can further include transmitting, by the third wireless transceiver of the second computing device, the pump sensor data received by the second wireless transceiver of the second computing device, to a server via a second network different than the first network. The server can include a data processor, a central field controller, and a memory. The method can also include processing, by the central field controller, the pump sensor data received from the third wireless transceiver of the second computing device. The method can further include providing the processed pump sensor data.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

### DESCRIPTION OF DRAWINGS

These and other features will be more readily understood from the following detailed description taken in conjunction with the accompanying drawings, in which:

FIG. 1 is a diagram illustrating an example architecture for a parallel network for a pump monitoring and control system configured with respect to a fluid production environment;

FIG. 2 is a diagram illustrating an exemplary embodiment of a pump monitoring and control system in operation with respect to a pump configured within the fluid production environment;

FIG. 3 is a diagram illustrating one exemplary embodiment of a method of operation of a pump monitoring and control system configured within a fluid production environment using the exemplary parallel network of FIG. 1; and

FIG. 4 is a block diagram of an exemplary computing system in accordance with an illustrative implementation of the sensor reset system of FIG. 1.

It is noted that the drawings are not necessarily to scale. The drawings are intended to depict only typical aspects of the subject matter disclosed herein, and therefore should not be considered as limiting the scope of the disclosure.

### DETAILED DESCRIPTION

A fluid production field may include different types of pumping units arranged at different well sites. The pumping units at the well sites can utilize various pumping methods to extract fluids, for example oil, from underground fractures. Each pumping unit can be driven and controlled by several devices. For example, the pumping unit can include a variable speed drive, a downhole sensor, and pressure gauges. These devices read different types of data and can deliver the respective data to a remote terminal unit (e.g., an RTU). The RTU can be configured to gather data from the devices at each well location. The RTU can provide the gathered data through wireless communication networks to computing devices, such as servers, which can be configured to process the data. The computing devices can be remotely located from the RTU and can, in some configurations, be many kilometers away from the RTU. The remote computing devices can include field controller software, which can be the initial data processing point for the data being provided by the RTUs.

The RTUs and the remote computing devices can be configured as or within a SCADA system. The wireless communication protocol used within a SCADA system can vary between different entities, or customers, associated with the SCADA system. For example, in some configurations, the SCADA system can be configured with wireless communication protocols which can include, but are not limited to, WiMAX, AirMAX, Long Term Evolution (LTE), Enhanced Data Rates for Global Evolution (EDGE), radio frequency (RF), or the like. These wireless communication protocols can be configured to support different coverage ranges that may extend from few meters to several kilometers.

When the SCADA system is initially configured, the wireless network and protocols may be implemented to support the range of distances between the wells and a communication tower. During the initial configuration, access points and/or customer premise equipment (CPE) implementing a wireless communication protocol can be installed and connected to an Ethernet port on each RTU. Each CPE can be configured with an IP address that can be provided and controlled by a Network Management System (NMS). The CPE can provide a first point-to-point network between the RTU and the communication tower. However, when newly drilled wells are constructed outside of the coverage range of the first network it can be difficult or impossible to transfer data to the SCADA field controller software using the first network.

To address this, an extended second network, can be configured by installing third -party networking CPEs that support any wireless communication protocol. The CPEs of the second network will be installed in each RTU that is located outside the coverage range. A CPE of the second network can be connected to a free Ethernet port of an RTU and can be configured with a custom IP address so that the RTU acts as a base station. The CPEs in the second network can be coupled to the RTU that is configured within the client's coverage area via a second Ethernet port. The CPEs in the second network can be configured within the communication range of the first network, yet include different IP addresses than the CPEs of the first network. The access point can then be configured as a hub to collect data from all stations. A version of the field controller software can be configured on the RTU configured as the access point. This RTU can be connected to the first, the client's private network, and also to the second network, which can be the extended and customized network. In this way, the RTU, can collect data and send it through the first network and the RTU can also act as a field controller to the other stations to gather data from the RTUs in the second network and to provide the data to the field controller software via the first network.

An improved pump monitoring and control system is provided herein including systems, methods, and computer-readable mediums for monitoring and controlling pumps in a fluid production environment using one or more networks. Sensor data identifying operational data associated with the machinery to which the sensors are coupled can be received by a first computing device including a first wireless transceiver. The first wireless transceiver can enable the first computing device to transmit the sensor data over a first network to a second computing device that can be similarly configured with a corresponding first wireless transceiver. The second computing device can also include a second, different wireless transceiver which can be configured to transmit the sensor data to the pump monitoring and control server via a second network that is different than the first network. The second computing device can further include a remote field controller (RFC) that can be coupled to the pump monitoring and control server to form a parallel or back-up network with a scheduler which is already installed on the pump monitoring and control server and configured to process data received directly from the RFC. By configuring the RFC within the second computing device, the pump monitoring and control server can directly communicate with the first computing device, via the first network established by the wireless transceivers configured on the first and second computing devices. Communication with the first computing device would be otherwise unattainable due to changes in the network configuration or the telecommunication equipment and/or interfaces associated with the first computing device.

In this way, the improved pump monitoring and control system described herein can provide a back-up network for heterogeneously configured computing devices within a fluid production environment. By configuring the computing devices with wireless transceivers as described herein to form a first network, as well as configuring select computing devices with remote instantiations of field controller functionality, a robust, affordable, and scalable network of computing devices associated with sensors deployed in a geographically diverse arrangement can be achieved. This network can implement a slave-host network model to ensure that a legacy deployment of computing devices and telecommunication equipment can remain functional within a fluid production environment without requiring expensive, customized upgrades to each and every individual computing device.

Embodiments of systems and corresponding methods for providing a network for pump control and monitoring are discussed herein. However, embodiments of the disclosure can be employed for monitoring and controlling other types of machinery in an oil production environment without limit.

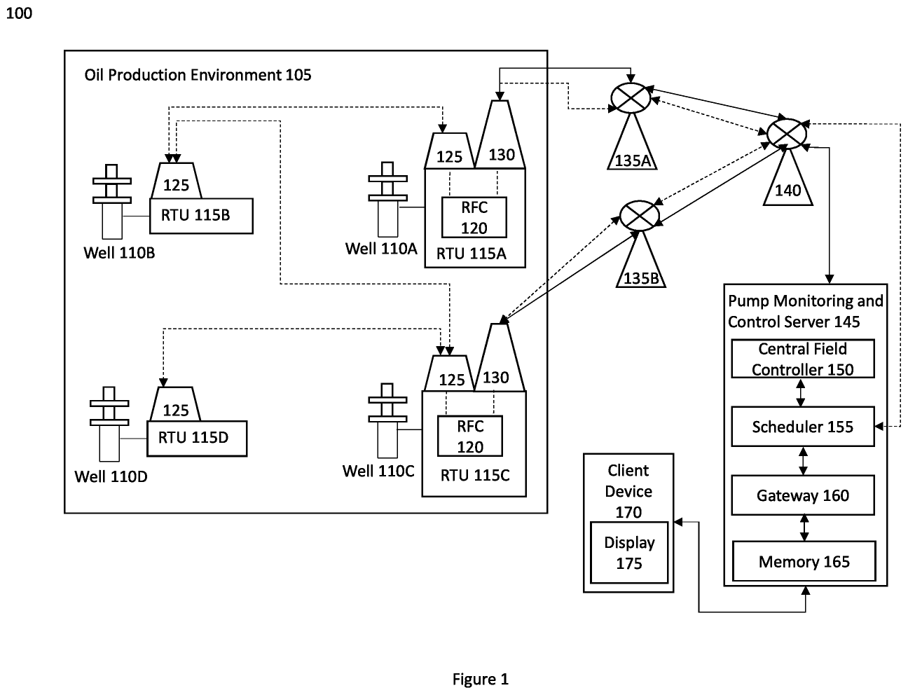

FIG. 1 is a diagram illustrating an example architecture for a parallel network for a pump monitoring and control system 100 configured with respect to a fluid production environment. In some embodiments, the fluid production environment 105 can be an oil production environment 105 and the fluid being produced can include oil. The architecture includes a fluid production environment 105, a plurality of telecommunication base stations 135, a telecommunication main station 140, a pump monitoring and control server 145, and a client device 170. The components of the oil production environment 105 and the pump monitoring and control server 145 can be included in a supervisory control and data acquisition (SCADA) system that can be configured by the operators of the oil production environment 105.

The oil production environment 105 includes a plurality of wells 110, such as wells 110A-110D. The wells may be configured to generate oil and can be configured with one or more pumps that are operable to pump the oil from sub-surface formations into processing systems configured to collection, process and distribute the oil further. Each of the wells 110 and the machinery associated therewith can be configured with one or more sensors to monitor various aspects of the operation of the well machinery and the well as a whole. The sensors can be coupled via a network to the pump monitoring and control server 145.

The sensors that are configured in relation to each well 110 can be coupled to a remote terminal unit (RTU) 115. The RTU 115 can be configured as an interface connecting the sensor-coupled machinery to the pump monitoring and control server 145. In some embodiments, the RTU 115 can be configured to apply parameter settings to control the machinery, such as the pump, at one or more well sites. The RTU 115 is a data communication module that is configured to perform serial communications using the MODBUS protocol. The RTU 115 reads the data from multiple sensors affixed to the pump or configured at the well site in real-time or near real-time and writes to some parameters if the RTU 115 receives a write command from the RFC 120 and/or the central field controller 150.

As shown in FIG. 1, the pump monitoring and control system 100 can include different configurations of RTUs 115. In a first configuration, as shown by RTU 115A, the RTU can include a first wireless transceiver 125 and a second wireless transceiver 130. In this first configuration, the RTU 115 can also include a RFC 120. In a second configuration, as shown by RTU 115B, the RTU 115 can include a first wireless transceiver, such as wireless transceiver 125, and can exclude a RFC, such as RFC 120. These different configurations can allow the RTUs 115 to communicate in a slave-host communication model and can operate to provide a parallel or back-up network to transmit and receive pump sensor or control data in situations where a particular RTU 115 may not include a telecommunications device suitable for communicating pump sensor data to a RTU 115 which includes a RFC 120. As shown in dashed lines, RTU 115B or RTU 115D can be slave RTUs that can be configured to transmit pump sensor or control data via a first wireless transceiver 125 to a host RTU, such as RTU 115A or RTU 115C.

An RTU 115 can, in some embodiments, include a RFC 120. The RFC 120 is similar to the central field controller 150 that can be configured on the pump monitoring and control server 145. When implemented within an RTU 115 that is configured with a first wireless transceiver 125 and a second wireless transceiver 130, the RFC 120 can operate to collect data from the RTUs 115 to which is it coupled, either locally, such as RTU 115A, or remotely, such as RTU 115B, and transmit the data, via the second wireless transceiver 130 to the pump monitoring and control server 145. For example, as shown in dashed lines, pump sensor data or control data received at a host RTU (e.g., RTU 115A or RTU 115C) via the first wireless transceiver 125 is processed by the RFC 120 that can be configured within the host RTU 115A or RTU 115C. The pump sensor and/or control data can then be provided from the RFC 120 to the second wireless transceiver 130. As shown via the dashed lines, the pump sensor and/or control data can be then directly transmitted to the scheduler 155 via base stations 135 and/or main stations 140. The RFC 120 acts to direct sensor data and/or command instructions between the pump monitoring and control server 145 and a particular RTU 115. Deploying the RFC 120 on RTUs 115 with a first wireless transceiver 125 and a second wireless transceiver 130 enables the central field controller 150 to direct data transmissions or receipt of data to/from a particular RTU 115 even though the RTU 115 is otherwise unreachable from the central field controller 150. For example, as shown via the dashed lines in FIG. 1, RTU 115B can be configured to communicate sensor and/or pump control data with the RFC 120 that can be installed on RTU 115C in the event the RFC 120 configured on RTU 115A is unable to establish direct communication with RTU 115B. As further shown by dashed lines, RTU 115C can then transmit sensor and/or pump control data directly to the scheduler 155 that is configured on the pump monitoring and control server scheduler 14. Because the pump sensor and/or control data associated with RTU 115B or RTU 115D has already been processed by a RFC 120 configured on a RTU 115, such as RTU 115A or RTU 115D, respectively, the pump sensor and/or control data can be forwarded directly to the scheduler 155 without initial processing by the central field controller 150.

RTUs 115 can include a first wireless transceiver 125 and/or a second wireless transceiver 130. The RTUs 115 can also be connected to each other via a parallel or back-up network formed between the first wireless transceivers 125. The parallel network can be a private network that facilitates near-field or local network data sharing. The parallel network can be implemented using the first wireless transceivers 125 and one of the existing Ethernet ports available on the RTU 115 which is separate from the ports used for the configuration of the second wireless transceiver 130. The second wireless transceivers 130 can therefore act as a hub or a host to RTUs 115 which do not include a RFC 120. For example, RTU 115A, can serve as a host or hub to RTU 115B. When deployed, the first wireless transceiver 125 of one RTU 115, such as RTU 115D can communicate pump sensor data and/or control information with a first wireless transceiver 125 configured on a second RTU 115, such as RTU 115C. The second RTU 115 (e.g., RTU 115C) can then further transmit the pump sensor data and/or control information via the RFC 120 and using the second wireless transceiver 130 that is configured on the pump monitoring and control server 145. In some embodiments, the RTU 115C can directly transmit pump sensor data and/or control information to the scheduler 155 via the second wireless transceiver 130. In this example, RTU 115D can be configured as a slave device to communicate data with RTU 115C which can be configured as a host device and includes a RFC 120.

The pump monitoring and control system 100 also includes a second computing device, such as the pump monitoring and control server 145 connected to host RTUs 115 via a network implemented over one or more base stations 135 (e.g., such as base stations 135A and 135) and one or more main stations, such as main station 140. The network can include, for example, any one or more of a campus area network (CAN), a metropolitan area network (MAN), a wide area network (WAN), a broadband network (BBN), the Internet, a WiMAX network, or the like. Further, the network can include, but is not limited to, any one or more of the following network topologies, including a bus network, a star network, a ring network, a mesh network, a star-bus network, tree or hierarchical network, and the like.

In certain aspects, the pump monitoring and control server 145 can be a cloud computing server of an infrastructure-as-a-service (IaaS) and can support a platform-as-a-service (PaaS) and software-as-a-service (SaaS) services. The pump monitoring and control server 145 can be implemented remotely from the RTUs 115 and can be configured by the client device 170. As shown in FIG. 1, the pump monitoring and control server 145 includes a central field controller 150, a scheduler 155, a gateway 160, and a memory 165. In broad terms, the pump monitoring and control server 145 can be configured to receive the sensor data from the RTUs 115 and to process the received sensor data. The central field controller 150 can collect the data from the RTUs 115 and verifies the validity of the collected data. The central field controller 150 then transmits the scheduler 155. The scheduler 155 organizes the data into a data sequences, packages, or tasks that can provided as inputs to the gateway 160. The gateway 160 can write the data into a memory or database, such as the memory 165. In addition, the central field controller 150 can receive sensor control commands which can be transmitted from the client device 170. The field controller 150 can further execute instructions to transmit the sensor control commands to a particular RTU 115 who, in turn, may transmit the sensor control commands to the correspondent device (e.g. the pump control drive or any of the motor valves associated with a pump at a specific well 110 for which the particular RTU 115 is co-located).

As shown in FIG. 1, the pump monitoring and control server 145 includes a memory 165. The memory 165 can include a database or similar data structure that can be configured to store operating conditions, advisory statements, optimization action plans, sensor control commands, received sensor data, RTU 115 configuration data, wireless transceiver 125 or 130 configuration data, as well as telecommunication network data associated with the telecommunications base stations 135 and telecommunication main stations 140. The memory 150 can include executable instructions which cause the central field controller 150 to determine a particular slave-host configuration to be applied to an RTU 115 (e.g., RTU 115B as a slave device) and an RTU 115 configured with a RFC 120 (e.g., RTU 115A as a host device). In this way, the central field controller 150 can determine and implement a back-up or parallel network for the pump monitoring and control data generated and managed within the system 100.

As further shown in FIG. 1, the pump monitoring and control system 100 includes a client device 170. The client device 170 to which the pump monitoring and control server 145 is connected over a network can be, for example, desktop computers, mobile computers, tablet computers, mobile devices (e.g., a smartphone or PDA), or any other devices having appropriate processor, memory, and communications capabilities. The client device 170 includes a display 175. The client device 170 can include a client device that is used to configure one or more aspects of the SCADA system including the functionality associated with the RTUs 115, the RFCs 120, the central field controller 150, as well as the pump monitoring and control server 145. The client device 170 can be any computing device that is appropriately configured to receive user inputs and to display data or executable content associated with the pump monitoring and control system 100. For example, the client device 170 can be utilized to input configuration data associated with a RFC 120 that may be deployed on a particular RTU 115 in a host mode to enable communications with a RTU 115 that has been configured in a slave mode, such as RTU 115A serving as a communication host to RTU 115B. In some embodiments, the client device 170 can be used to receive inputs associated with configuring one or more of the wireless transceivers that may be configured on a particular RTU 115, such as a first wireless transceiver 125 that can be configured on RTU 115A or 115B, as well as a second wireless transceiver 130 that can be configured on an RTU 115 that is configured as a host and can include a RFC 120, such as RTU 115B. In some embodiments, the client device 170 can be utilized to input desired operating conditions for an oil well or oil-production machinery that is configured within the oil production environment 105.

Additionally, the client device 170 can display, via display 175, the current operating conditions, historical trends associated with the operating conditions, as well as advisory statements, optimization action plans, sensor data, configuration data associated with the wireless transceivers 125 and/or 130, as well as sensor control instructions or commands. The client device 170 can provide SCADA system data and/or data associated with the network of wireless transceiver devices that are configured within the pump monitoring and control system 100 via the display 175. SCADA system data and pump monitoring and control system data can be provided in graphical and textual formats. The graphical formats can include a variety of time-based graphs plotting the operating conditions and the application intervals used for a particular optimization action plan to make the data more easily interpretable to a user. The graphical formats can also include network diagrams and/or terrain-based maps of deployed communication devices including wireless transceivers 125 and 130, telecommunication base stations 135, and telecommunications main stations 140. In some embodiments, the client device 170 can include a mobile computing device, such as a smart-phone, tablet, or laptop computer that is connected to the pump monitoring and control server 145 via wireless or wired communication means.

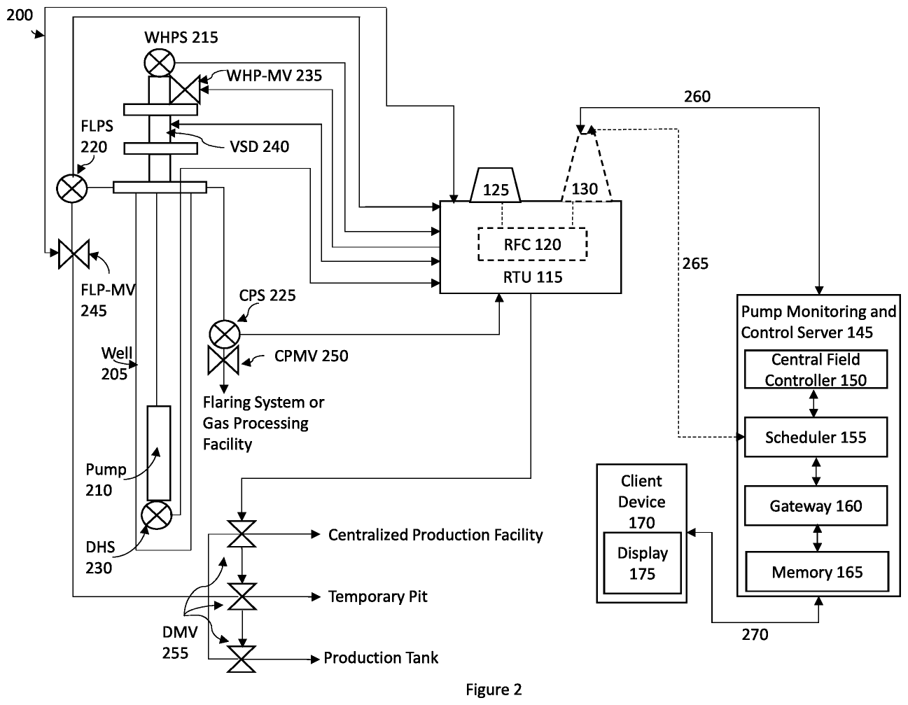

FIG. 2 is a diagram illustrating an exemplary embodiment of a pump monitoring and control system 200 in operation with respect to a pump configured within the oil production environment. The RTU 115, the pump monitoring and control server 145, and the client device 170 are similar in structure and function as those shown and described in relation to FIG. 1, except where noted otherwise.

As shown in FIG. 2, the exemplary pump monitoring and control system 200 includes a well 205. The well 205 can be a well that is configured for oil production. The well 205 includes a pump 210. The pump 210 can include an electric submersible pump, a progressive cavity pump, a sucker rod pump, and/or the like. A number of pump components are also included in the pump monitoring and control system 200. For example, the system includes a number of sensors that are configured to collect and provide sensor data about one or more aspects of the pump or the pump distribution system such as a well head pressure sensor (WHPS) 215, a flow line pressure sensor (FLPS) 220, a casing pressure sensor (CPS) 225, and a downhole sensor (DHS) 230. Additionally, the pump monitoring and control system 200 can include a variable speed drive that controls the speed of the pump motor and the operation pump motor, for example turning the pump motor on or off. Additional sensors may also be configured in relation to the well or the pump and can be configured to operate with the pump monitoring and control system 200. For example, the downhole sensor 230 can include sensors configured to measure the intake pressure and temperature, the discharge pressure and temperature, as well as the vibration characteristics of the pump 210 as it operates in the well 205.

As further shown in FIG. 2, the pump monitoring and control system 200 includes a number of pump motors and one or more motor valves. For example, a well head pressure motor valve (WHP-MV) 235 is configured atop the well, for example, as part of the well head configuration. The well head pressure motor valve 235 can be controlled in order to adjust the amount of pressure in the well head. The well head configuration shown in FIG. 2 also includes a variable speed drive (VSD) 240. The variable speed drive 240 is a physical drive device that can be configured to operate the pump at a variety of different speeds or frequencies, such as 50 or 3600 revolutions-per-minute. The pump monitoring and control system 200 can also include a flow line pressure motor valve (FLP-MV) 245, a casing pressure motor valve (CPMV) 250 and a distribution manifold (DMV) 255. The pump monitoring and control system 200 further includes a RTU 115 that is coupled via a network 260 to the pump monitoring and control server 145. The RTU 115 includes a first wireless transceiver 125 and in some embodiments, can also include a second wireless transceiver 130 shown in dashed lines. In some embodiments, the RTU 115 can also include a RFC 120 shown in dashed lines. The pump monitoring and control server 145 is coupled to the client device 170 via a network 265.

In operation, the pump monitoring and control system 200 shown in FIG. 2, generates sensor data from one or more sensors, such as the well head pressure sensor 215, the flow line pressure sensor 220, the casing pressure sensor 225, and the downhole sensor 230. Additionally, sensor data can be provided by the variable speed drive 240 to indicate the current speed of rotation of the pump motor, amperage of the pump motor, and the voltage rates applied to the pump motor. In some embodiments, the sensor data can be received by a RTU 115 which excludes a RFC 120. Once received, the sensor data can be transmitted 260 to the central field controller 150 configured on the pump monitoring and control server 145 using the second wireless transceiver 130. The sensor data is received by the pump monitoring and control system 145 where it is processed by the central field controller 150 before being passed to the scheduler 155 and the gateway 160 to be written into the memory 165 or stored in a database of sensor data configured within the memory 165.

Additionally, or alternatively, the pump monitoring and control system 200 shown in FIG. 2 can operation to receive the pump sensor and/or control data via from a slave RTU 115 via a first wireless transceiver 125 that is configured on a host RTU 115 which can include a RFC 120 (shown in dashed lines) and a second wireless transceiver 130 (shown in dashed lines on RTU 115). Once received data is processed by the RFC 120 and can be transmitted 265 via the second wireless transceiver 130 directly to the scheduler 155. The pump sensor and/or control data is received by the scheduler 155 and provided to the gateway 160 to be written into the memory 165 or stored in a database of sensor data configured within the memory 165.

The pump monitoring and control server 145 receives the sensor data from the RFC 120 configured within a RTU 115 and processes the received sensor data. The received sensor data can be formatted by the RFC 120 in a compressed, archivable file format, such as a ZIP file. The ZIP files received from the RFC 120 can be approximately 2 kB each and can be received at a rate of one ZIP file every minute. The ZIP file contains sensor data after it was polled or received from the various sensors described in relation to FIG. 2, such as the VSD 240, the WHPS 215, the DHS 230, or the like.

The received sensor data is further processed by the central field controller 150. The central field controller 150 coordinates receipt of sensor data and transmission of control instructions to and from the RFCs 120. The central field controller has direct communication to the RFCs configured within the RTUs 115 via the network connection enabled by the wireless transceivers 130. The sensor data can be written to a database of sensor data that is configured within the memory 165. In some embodiments, the pump monitoring and control server 145 can transmit 270 pump sensor and/or control data to the client device 170, for output, such as providing the data for display via the display 175.

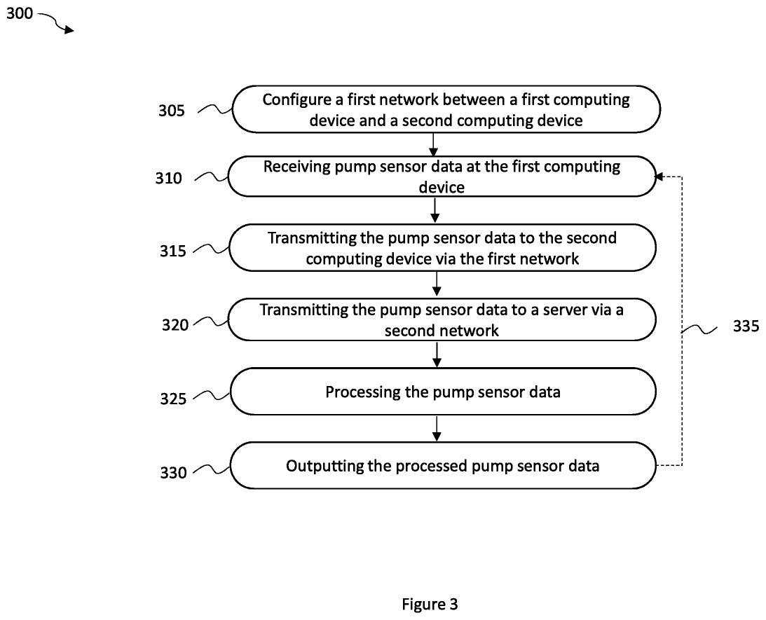

FIG. 3 is a diagram illustrating one exemplary embodiment of a method for implementing a back-up network for pump control and monitoring within an oil production environment 105 using the exemplary pump monitoring and control system 100 shown and described in relation to FIGS. 1 and 2. In certain aspects, embodiments of the method 300 can include greater or fewer operations than illustrated in FIG. 3 and the operations can be performed in a different order than illustrated in FIG. 3.

For example, in operation 305, the pump monitoring and control server 145 configures a first network between one or more RTUs 115. The first network can be implemented as a back-up network for use when one or more RTUs 115 are not configured with an RFC 120 and lack a second wireless transceiver 130. The network can be implemented by configuring the first wireless transceivers 125 of an RTU 115, such as RTU 115B, to exchange data with a first wireless transceiver 125 of an RTU 115 that is configured with an RFC 120, such as RTU 115D. The first network can be configured to identify individual RTUs 115 as slave devices or host devices. In some embodiments, pairs of slave RTUs 115 and their corresponding host RTUs 115 can be configured as RTU groups. RTU groups can be managed based on different attributes or policies by the central field controller 150. Additionally, the pump monitoring and control server 145 can configure the first network based on one or more network management applications configured on the pump monitoring and control server 145 and/or the client device 170.

In operation 310, the first computing device, such as RTU 115B or RTU 115D, receives pump sensor data. The pump sensor data can include sensor data from a well head pressure sensor, a flow line pressure sensor, a casing pressure sensor, a downhole sensor, and a pump motor speed sensor such as a variable speed drive sensor as described in relation to FIG. 2.

In operation 315, the first computing device, e.g., RTU 115B, transmits the pump sensor data to a second computing device, such as RTU 115A as shown in FIG. 1. Alternatively, as shown by a dashed line in FIG. 1, the RTU 115A can alternatively transmit the pump sensor data to a different RTU 115, such as RTU 115C. The RTU 115 can transmit the pump sensor data as a slave device to any host RTU 115 that includes a second wireless transceiver 130 and for which the slave RTU 115 is configured within the RFC 120 of the second RTU 115.

In operation 320, the second computing device, e.g., the second RTU 115, such as RTU 115A, transmits the pump sensor data received from the first RTU 115, e.g., RTU 115B via a second network. The second network can be a client-provided network that is different than the first network established between the sensing RTUs 115 and the RTUs 115 that are configured with an RFC 120 and a second wireless transceiver 130. The second network can include one or more base stations 135 and one or more main stations 140 which are operable to provide data transmissions between the RTU 115 configured with the RFC 120 and the pump monitoring and control server 145.

In operation 325, the pump monitoring and control server 145 can process the received pump sensor data. The pump monitoring and control server 145 can perform a variety of processing on the sensor data including monitoring the sensor data for anomalous operating conditions, generating reports, alarms or notifications in regard to the pump sensor data, as well as processing sensor or pump control data. Additionally, the pump monitoring and control server 145 can process the sensor data according to one or more sensor management applications configured on the pump monitoring and control server 145 and/or the client device 170.

In operation 330, the pump monitoring and control server 145 outputs the processed pump sensor data. In some embodiments, outputting can include providing pump sensor data to a client computing device that is coupled to the server 145, such as client device 170 where the pump sensor data can be displayed via display 175. In some embodiments, the server 145 can output the processed pump sensor data to a memory or database, such as a database that is configured within the memory 165. In some embodiments, the processed pump sensor data can include executable data requiring additional or subsequent inputs to execute functionality associated with the sensor data.

In operation 335, the pump monitoring and control server 145 can perform operations 305-330 iteratively based a predetermined event, such as a change in one or more RTUs available or otherwise configured within the first network. For example, based on RTU 115A losing power or a failure of the second wireless transceiver 130 of RTU 115A, the pump monitoring and control 145 can re-initiate operations 305-330 such that sensor data from RTU 115B is no longer transmitted via the first network to RTU 115A, but instead can be transmitted to RTU 115C as a result of reconfiguring the first network. In some embodiments, the pump monitoring and control server 145 can reinitiate operations 305-330 based on a user-configured time interval since previously performing operation 305. Time intervals can include intervals of minutes, such intervals that are 5-15, 15-30, 30-60, or 60-180 minutes in duration. Time intervals can further include intervals of days, such as intervals that are 0.5-1, 1-3, or 3-5 days in duration or longer.

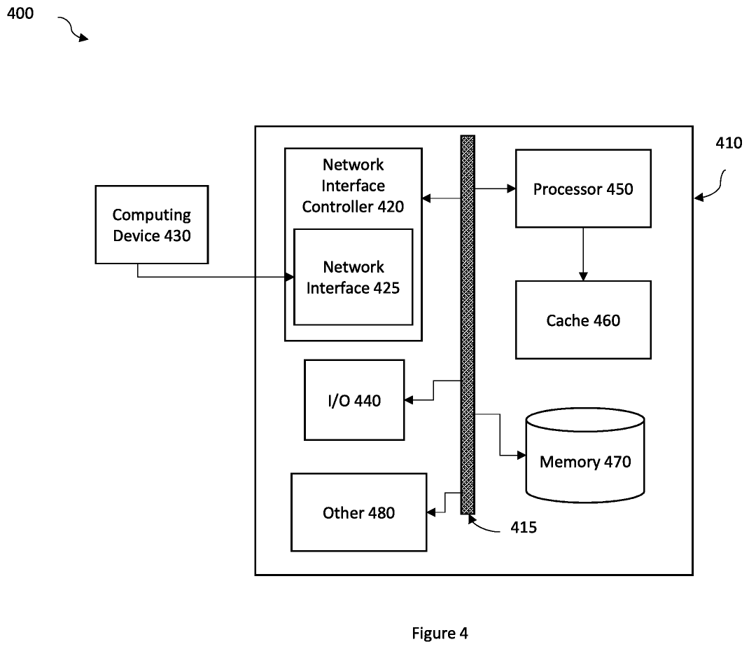

FIG. 4 is a block diagram 400 of a computing system 410 suitable for use in implementing the computerized components described herein. In broad overview, the computing system 410 includes at least one processor 450 for performing actions in accordance with instructions, and one or more memory devices 460 and/or 470 for storing instructions and data. The illustrated example computing system 410 includes one or more processors 450 in communication, via a bus 415, with memory 470 and with at least one network interface controller 420 with a network interface 425 for connecting to external devices 430, e.g., a computing device (such as a WHPS sensor 215, an RTU 115 configured with or without a RFC 120, a client device 170, or a pump monitoring and control server 145). The one or more processors 450 are also in communication, via the bus 415, with each other and with any I/O devices at one or more I/O interfaces 440, and any other devices 480. The processor 450 illustrated incorporates, or is directly connected to, cache memory 460. Generally, a processor will execute instructions received from memory. In some embodiments, the computing system 410 can be configured within a cloud computing environment, a virtual or containerized computing environment, and/or a web-based microservices environment.

In more detail, the processor 450 can be any logic circuitry that processes instructions, e.g., instructions fetched from the memory 470 or cache 460. In many embodiments, the processor 450 is an embedded processor, a microprocessor unit or special purpose processor. The computing system 410 can be based on any processor, e.g., suitable digital signal processor (DSP), or set of processors, capable of operating as described herein. In some embodiments, the processor 450 can be a single core or multi-core processor. In some embodiments, the processor 450 can be composed of multiple processors.

The memory 470 can be any device suitable for storing computer readable data. The memory 470 can be a device with fixed storage or a device for reading removable storage media. Examples include all forms of non-volatile memory, media and memory devices, semiconductor memory devices (e.g., EPROM, EEPROM, SDRAM, flash memory devices, and all types of solid state memory), magnetic disks, and magneto optical disks. A computing device 410 can have any number of memory devices 470.

The cache memory 460 is generally a form of high-speed computer memory placed in close proximity to the processor 450 for fast read/write times. In some implementations, the cache memory 460 is part of, or on the same chip as, the processor 450.

The network interface controller 420 manages data exchanges via the network interface 425. The network interface controller 420 handles the physical, media access control, and data link layers of the Open Systems Interconnect (OSI) model for network communication. In some implementations, some of the network interface controller's tasks are handled by the processor 450. In some implementations, the network interface controller 420 is part of the processor 450. In some implementations, a computing device 410 has multiple network interface controllers 420. In some implementations, the network interface 425 is a connection point for a physical network link, e.g., an RJ 45 connector. In some implementations, the network interface controller 420 supports wireless network connections and an interface port 425 is a wireless transceiver such as wireless transceiver 125 and 130. In some implementations, wireless transceiver 125 can be a nano-device configured to support data communications over multiple bandwidths ranges from 5-50 Hz for devices positioned up to 5 km apart. The nano-device wireless transceiver 125 can transmit data at 2.4 GHz up to 150 MB/sec. In some implementations, the wireless transceiver 130 can include a wireless transceiver configured to transmit and receive data using the WiMAX broadband communication standard. Generally, a computing device 410 exchanges data with other network devices 430, such as computing device 430, via physical or wireless links to a network interface 425. In some implementations, the network interface controller 420 implements a network protocol such as LTE, TCP/IP Ethernet, IEEE 802.11, IEEE 802.16, or the like.

The other computing devices 430 are connected to the computing device 410 via a network interface port 425. The other computing device 430 can be a peer computing device, a network device, or any other computing device with network functionality. For example, a computing device 430 can be a WHPS sensor 215, a RTU 115, a client device 170, and/or a pump monitoring and control system which may be configured within the pump monitoring and control server 145 illustrated in FIG. 1. In some embodiments, the computing device 430 can be a network device such as a hub, a bridge, a switch, or a router, connecting the computing device 410 to a data network such as the Internet.

In some uses, the I/O interface 440 supports an input device and/or an output device (not shown). In some uses, the input device and the output device are integrated into the same hardware, e.g., as in a touch screen. In some uses, such as in a server context, there is no I/O interface 440 or the I/O interface 440 is not used. In some uses, additional other components 480 are in communication with the computer system 410, e.g., external devices connected via a universal serial bus (USB).

The other devices 480 can include an I/O interface 440, external serial device ports, and any additional co-processors. For example, a computing system 410 can include an interface (e.g., a universal serial bus (USB) interface, or the like) for connecting input devices (e.g., a keyboard, microphone, mouse, or other pointing device), output devices (e.g., video display, speaker, refreshable Braille terminal, or printer), or additional memory devices (e.g., portable flash drive or external media drive). In some implementations an I/O device is incorporated into the computing system 410, e.g., a touch screen on a tablet device. In some implementations, a computing device 410 includes an additional device 480 such as a co-processor, e.g., a math co-processor that can assist the processor 450 with high precision or complex calculations.

Exemplary technical effects of the methods, systems, and non-transitory machine readable storage mediums described herein include, by way of non-limiting example, configuring a network to transmit sensor data and control data within an oil production environment. By configuring a plurality of computing devices with one or more wireless transceivers, a slave-host networking model can be implemented to allow a central field controller to receive sensor data and transmit control data to a RTU 115 that does not have direct connection with the central field controller. In this way, the central field controller can receive and process sensor data received from a larger number of RTUs which do not have direct connections to the server on which the central field controller is configured. This provides for a pump monitoring and control system 100 that can efficiently support upgrade or retro-fit operations of legacy computing devices which may no longer be able to transmit or receive sensor data or control data via the legacy network previously used to couple the legacy computing devices. Thus the system represents an improvement of computer functionality within a SCADA system that monitors and controls well machinery based on the sensor data. In this way, the improved pump monitoring and control system 100 can provide faster, more reliable instructions to a larger number of coupled computing devices in order to maintain machinery operation and/or pump production as close as possible to desired operating conditions.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in analog electronic circuitry, digital electronic circuitry, and/or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

1. A method comprising:
configuring a first network between a first computing device and a second computing device;
receiving pump sensor data, by the first computing device including a data processor and a first wireless transceiver, the pump sensor data generated by one or more sensors affixed to a pump within a fluid production environment and coupled to the first computing device;
transmitting, by the first wireless transceiver of the first computing device, the pump sensor data to the second computing device via the first network, the second computing device including a data processor, a remote field controller, a second wireless transceiver, and a third wireless transceiver;
transmitting, by the third wireless transceiver of the second computing device, the pump sensor data received by the second wireless transceiver of the second computing device, to a server via a second network different than the first network, the server including a data processor, a central field controller, and a memory;
processing, by the central field controller, the pump sensor data received from the third wireless transceiver of the second computing device; and,
providing the processed pump sensor data.

2. The method of claim 1, wherein the one or more sensors include one of a well head pressure sensor, a flow line pressure sensor, a casing pressure sensor, a downhole sensor, and a pump motor speed sensor.

3. The method of claim 1, wherein the first network is configured as an extension of the second network based on the first wireless transceiver being out of communication range of a base station coupled to the central field controller.

4. The method of claim 1, wherein the first computing device can be configured as a host remote terminal unit and can be communicatively coupled to one or more slave remote terminal units.

5. The method of claim 4, wherein the one or more sensors are coupled to the one or more slave remote terminal units.

6. The method of claim 1, wherein the first wireless transceiver is configured to transmit the pump sensor data via the first network using one of a WiMAX, AirMAX, Long Term Evolution (LTE), Enhanced Data Rates for Global Evolution (EDGE), and radio frequency (RF) wireless communication protocol.

7. The method of claim 1, wherein the first computing device can be configured with an IP address that is included in a range of IP addresses associated with the second computing device.

8. The method of claim 1, wherein configuring the first network further includes reconfiguring the first network by the central field controller based an occurrence of one or more predetermined events.

9. The method of claim 8, wherein the first network can be reconfigured by the central field controller based on one of a failure of the first computing device, the second computing, device, and a user-configured time interval.

10. A system comprising:
a plurality of first computing devices, each of the first computing devices including a processor and a first wireless transceiver configured to transmit pump sensor data received by one or more sensors affixed to a pump within a fluid production environment and coupled to at least one of the first computing devices;
a plurality of second computing devices, each of the second computing devices including a data processor, a remote field controller, a second wireless transceiver and a third wireless transceiver, the second wireless transceiver configured to receive the pump sensor data transmitted from the first wireless transceiver of at least one of the first computing devices via a first network configured between the at least one of the first computing device and the second computing device, and the third wireless transceiver configured to transmit the pump sensor data to a server via a second network different than the first network, and,
a server, including a central field controller, a memory storing instructions and one or more data processors configured to execute the instructions, which, when executed, cause the one or more data processors to perform operations comprising:
configuring the first network between the first computing device and the second computing device;
receiving the pump sensor data transmitted from the third wireless transceiver of the second computing device via the second network,
processing, by the central field controller, the received pump sensor data; and,
providing the processed pump sensor data.

11. The system of claim 10, wherein the one or more sensors include one of a well head pressure sensor, a flow line pressure sensor, a casing pressure sensor, a downhole sensor, and a pump motor speed sensor.

12. The system of claim 10, wherein the first network is configured as an extension of the second network based on the first wireless transceiver being out of communication range of a base station coupled to the central field controller.

13. The system of claim 10, wherein the first computing device can be configured as a host remote terminal unit and can be communicatively coupled to one or more slave remote terminal units.

14. The system of claim 13, wherein the one or more sensors are coupled to the one or more slave remote terminal units.

15. The system of claim 10, wherein the first wireless transceiver is configured to transmit the pump sensor data via the first network using one of a WiMAX, AirMAX, Long Term Evolution (LTE), Enhanced Data Rates for Global Evolution (EDGE), and radio frequency (RF) wireless communication protocol.

16. The system of claim 10, wherein the first computing device can be configured with an IP address that is included in a range of IP addresses associated with the second computing device.

17. The system of claim 10, wherein configuring the first network further includes reconfiguring the first network by the central field controller based an occurrence of one or more predetermined events.

18. The system of claim 17, wherein the first network can be reconfigured by the central field controller based on one of a failure of the first computing device, the second computing, device, and a user-configured time interval.

19. The system of claim 10, wherein the pump sensor data includes control data associated with an operation of the pump and the pump sensor data is received in a compressed format.

20. A non-transitory machine readable storage medium containing program instructions, which when executed by a data processor cause the data processor to perform operations comprising:
configuring a first network between a first computing device and a second computing device;
receiving pump sensor data, by the first computing device including a data processor and a first wireless transceiver, the pump sensor data generated by one or more sensors affixed to a pump within a fluid production environment and coupled to the first computing device;
transmitting, by the first wireless transceiver of the first computing device via the first network, the pump sensor data to the second computing device via the first network, the second computing device including a data processor, a remote field controller, a second wireless transceiver, and a third wireless transceiver;
transmitting, by the third wireless transceiver of the second computing device, the pump sensor data received by the second wireless transceiver of the second computing device, to a server via a second network different than the first network, the server including a data processor, a central field controller, and a memory;
processing, by the central field controller, the pump sensor data received from the third wireless transceiver of the second computing device; and,
providing the processed pump sensor data.
